(19) United States
(12) Patent Application Publication
(10) Pub. No.: US 2004/0004069 A1
(43) Pub. Date: Jan. 8, 2004

(54) Heat warning devices directly applicable to hot surfaces

(76) Inventor: William S. Lerner, New York, NY (US)

Correspondence Address: Steven Horowitz, Counselor At Law, Suite 700, 295 Madison Avenue, New York, NY, 10017, US

(21) Appl. No.: 10/447,510

(22) Filed: May 28, 2003

Related U.S. Application Data
(63) Continuation-in-part of application No. 10/429,111, filed on May 2, 2003.
Application No. 10/429,111 is a continuation-in-part of application No. 10/238,348, filed on Sep. 10, 2002.
Application No. 10/238,348 is a continuation-in-part of application No. 09/788,594, filed on Feb. 21, 2001, now Pat. No. 6,639,190.

(51) Int. Cl. H05B 3/68

(52) U.S. Cl. 219/445.1; 219/448.11

(57) ABSTRACT

Heat warning safety device comprising thermochromic ink or epoxy in the form of a heat warning symbol sprayed, stamped, stenciled, silk screened, embossed to the hot surfaces of appliances. The device is invisible when cold and is visible when a threshold temperature is reached. In a second version when cold the device shows only the outline of the warning symbol and when hot shows the full symbol. A plurality of these versions of the devices can be placed on various parts of appliances to maximize the effectiveness of the warning system and to tailor it both to children who need guidance as to where to look for said symbols and to adults as to whom the impact is greatest when the warning symbol appears from a point of invisibility. Alternatively, the warning symbol appears on the lip of a mug and advertises the staying power of the hot liquid therein.

### PRIORITY INFORMATION

This patent application is a continuation-in-part patent application of U.S. patent application Ser. No. 10/429,111 entitled Heat Warning devices Directly Applicable to Hot Surfaces filed May 2, 2003 by William Lerner, incorporated herein by reference, which application is a continuation-in-part of U.S. patent application Ser. No. 10/238,348 previously filed by Applicant and inventor William S. Lerner on Sep. 10, 2002 and which is incorporated herein by reference, said application itself being a continuation in part of application Ser. No. 09/788,594 filed by Applicant Lerner on Feb. 21, 2001 which is also incorporated herein by reference in its entirety.

### FIELD OF THE INVENTION

The present invention relates to safety devices used in cooking or other activities involving hot surfaces, and in particular it relates to safety devices applied directly to the hot surfaces and which alert someone that the surface of a stove or other appliance or device is too hot to touch.

### BACKGROUND OF THE INVENTION

Applicant's previous applications including U.S. patent application Ser. No. 10/238,348 which has been published and Applicant's U.S. Pat. No. 6,104,007 to Lerner, incorporated herein by reference, have explained in detail the need for a heat warning safety device to notify users that a particular surface remains hot. As explained, a prime purpose is to warn children in a household setting of the need not to touch particular surfaces. Another prime purpose is to warn adults of the same thing.

Over two million people in the United States suffer burns due to thermal injuries each year. All you need is one second of contact at a temperature of 167 degrees Fahrenheit for an adult t (160 degrees Fahrenheit for a child) to cause a burn.

As previously explained, versatility is an important aspect of the heat warning safety devices in that they should be applicable to any surface that can be hot or remain hot. Accordingly, previous applications by Applicant disclose detachable heat alert safety devices. However, such devices are subject to the risk of being tampered with and removed by children. On the other hand, heat warning safety devices that are built in to the appliance are not versatile. They cannot easily be applied to any appropriate surface. Any device by its nature also uses up physical space since the thermochromic composition has a container and the container has to be attached to the surface of the appliance by either a magnet, an adhesive layer or some other attachment element. Consequently, the heat warning safety device typically juts out of the surface. That may make the surface bulkier.

Furthermore, the heat warning safety device that appears on the surface of an appliance necessarily uses up a certain amount of visual space. In other words, the surface of an appliance has a logo on it and possible other information such as instructions. It is important for appliance manufacturers to allow their logo to stand out. It is well established principle of writing advertising copy that having too busy a visual environment makes it difficult to catch the attention of the viewer to the desired message; whereas empty visual space near the message draws the viewer's eye to the message. It is therefore desirable for any heat warning device to minimize the amount of visual space it uses on the surface of the appliance.

In addition, while minimizing the visual space used by a heat warning safety device may be desirable on the hot surface of an appliance, the countervailing consideration is that children cannot be expected to know where to look for heat warning without a conspicuous symbol conveying the heat warning. On the other hand, since adults could reasonably be expected to be taught to look at a surface to see whether a heat warning appears on the surface with a minimized visual prompt, and since children may not be similarly trainable, there is also a need for a heat warning safety device that is custom tailored for both children and adults.

Furthermore, while known heat warning safety devices can be made to fit a curved or a straight surface, one of such devices would not be expected to physically fit against both a curved and a straight surface.

There is also a need for a heat warning safety device that can communicate different degrees to which the surface of the appliance or other object is dangerously hot, i.e., hot versus very hot.

There is thus a need for a heat warning safety device that addresses the above concerns and does not require a container to house it and which can be applied directly to a surface in a simple manner. Furthermore, there is a need for such a device that minimizes the amount of visual space that it uses on the surface.

In addition, certain appliances, for example a toaster, may have multiple surfaces that are not all the same degree of dangerously hot and which would ideally require separate heat warning devices on each surface. Given that and the fact that as previously mentioned each such device uses up physical and visual bulk, it is all the more necessary to have devices or an assembly of devices that do not use up so much physical and visual space.

There is a need for an assembly of heat warning devices that can be placed on multiple surfaces of an appliance or object having hot surfaces. There is also a need for such an assembly each of whose devices has the mentioned advantages of the individual devices.

There is also a need for a heat warning safety device that maximizes the visual impact of the warning it communicates. In other words, there is a need to maximize the visual disparity between the appearance of the device when the surface is not dangerously hot and the appearance of the device when the surface is dangerously hot and a warning is being communicated.

In light of the above discussion there is a need for a device and an assembly of such devices that achieves all of the above objectives and which is also suitable for temperatures at least up to a high temperature of a gas oven (500° F.) since many appliances get that hot. There is also a need for a device and an assembly of such devices that is suitable for temperatures at least 300 degrees Fahrenheit since thermochromic compositions that are commonly available are reliably stable at cycling back and forth at that temperature and certain surfaces that require a warning device will not get hotter than that temperature.

It is believed that no heretofore known product simultaneously meets these requirements. The present invention does.

### SUMMARY OF THE INVENTION

The present invention is a heat alert safety device comprising thermochromic ink or epoxy material in the form of a heat warning symbol that is directly applied to a hot surface such as by being sprayed, stamped, stenciled, silk screened, embossed to the hot surface of the appliance. For example, the letters “HOT” are a common type of heat warning symbol. The device is invisible when cold (meaning when not dangerously hot) and is visible when a threshold temperature is reached. In a second version when not dangerously hot the device shows only the outline of the heat warning symbol and when hot shows the full symbol. A plurality of these versions of the heat alert safety devices can be placed on various parts or surfaces of an appliances or other hot surfaces to maximize the effectiveness of the warning system and to tailor the heat alert warning system to both children, who need guidance as to where to look for said warning symbols, and to adults, as to whom the impact is greatest when the warning symbol appears after being invisible. In an alternative embodiment, the warning symbol appears on the lid of a coffee cup and on the lip of a mug that holds a hot liquid. In these alternative embodiments, the heat warning symbol serves the supplementary purpose of advertising the staying power of the heat of the liquid, such as coffee.

The thermochromic composition and device is entirely constructed out of material able to withstand repeated cycling to a temperature of approximately 300 degrees Fahrenheit or more, and able to withstand rough treatment. The thermochromic material is shaped in a predetermined symbol or shape, such as the English letters “HOT” or such letters in another language, or in the background of such a symbol, communicating to a viewer that a surface is dangerously hot. The symbol may also take the form of a exclamation point, an international “no” symbol superimposed a stick diagram of a figure touching a surface, a stylized human face showing shock or pain, a representation of flames, or any other recognizable warning symbol. Preferably the symbol or its background should lie in the color range red-orange-yellow, commonly recognized colors of both high temperature objects and of required caution. Alternatively an abstract pattern such as alternating wavy lines or a field of exclamation points, normally invisible and becoming red and black at a predetermined temperature, can be continued across a front or back surface of the button, so that portion of the pattern visible to a viewer on the front side of the button will suffice to convey the warning.

### OBJECTS AND ADVANTAGES

The following important objects and advantages of the present invention are:

(a) to provide a heat warning safety device that is versatile enough to be applied to any surface;

(b) to provide such a device that cannot be tampered with by children or even by adults;

(c) to provide such a device that does not use up a significant amount of physical space;

(d) to provide such a device that does not use up a significant amount of visual space;

(e) to provide such a device that can be custom tailored for both children and adults;

(f) to provide such a device wherein the same device can be applied to both a straight surface and a curved surface;

(g) to provide such a device that can communicate differing degrees of dangerously hot, i.e. differing levels of heat;

(h) to provide such a device that is easy to apply and easy to manufacture;

(i) to provide such a device that can withstand high temperatures, i.e. 300 degrees Fahrenheit;

(j) to provide such a device that can form part of an assembly of such devices covering multiple surfaces of a particular appliance or object;

(j) to provide such a device that can maximize the visual impact of the heat warning symbol by maximizing the disparity between the warning symbol when cold and the symbol when dangerously hot;

(k) to provide a device that instantly warns anyone including a child that the surface of an appliance or other hot object is too hot to touch,

(l) to provide a versatile heat warning device that can be applied to and used on the widest possible range of surfaces and materials

(m) to provide a heat warning device that is easy to manufacture and that can be either installed onto the stove (or other appliance's) heating element or can be manufactured as part of the stove,

(n) to provide a heat warning device for stoves that can be calibrated to produce a warning symbol only when a certain temperature, such as 115 degrees Fahrenheit, is reached and that can remain in signaling mode as long as such temperature is exceeded by the appliance surface,

(o) to provide a heat warning device as above that makes use of thermochromic compositions that change color when a certain temperature is reached, such as cholesteric or chiral nematic liquid crystals or cadmium sulfide semiconductors designed to change color when a certain temperature is reached, and

(p) to provide a heat warning device that is readable by children,

### BRIEF DESCRIPTION OF THE DRAWINGS

FIG. 1 is an isometric view of the assembly of the present invention on an unheated toaster.

FIG. 2 is an isometric view of the assembly of the present invention on a heated toaster.

FIG. 3 is a fragmentary plan view of one of the type one devices of the assembly of the present invention when cold.

FIG. 4 is a fragmentary plan view of one of the type one devices of the assembly of the present invention when hot.

FIG. 5 is a sectional view taken along line 5-5 of FIG. 4.

FIG. 6 is a fragmentary plan view of one of the type two devices of the assembly of the present invention when cold.

FIG. 7 is a fragmentary plan view of one of the type two devices of the assembly of the present invention when hot.

FIG. 8 is a sectional view taken along line 8-8 of FIG. 7.

FIG. 9 is an isometric view of a cup and lid with a segmented warning symbol in accordance with an alternative embodiment of the present invention having thermochromic composition capable of depicting the words “OK”, “HOT” and “VERY HOT” and with the segment “HOT” active both on the lid and on the cup.

FIG. 10 is an isometric view of a lid with an alternative embodiment of a segmented warning symbol in accordance with the present invention having thermochromic composition capable of depicting the words “OK” and “HOT” and with the segment “OK” active.

FIG. 11 is a mug whose lip is red to advertise and warn individuals that the liquid inside it is hot

FIG. 12 is a mug whose lip contains a heat warning symbol to advertise and warn individuals that the liquid inside it is hot.

FIG. 13A is tri-segmented heat warning symbol for any surface in accordance with the present invention, and

FIG. 13B is a bi-segmented heat warning symbol for any surface in accordance with the present invention.

FIG. 14 is a top plan view of a heat warning symbol of the present invention located on the outer perimeter of a metal grill of a gas stove's heating element.

### DETAILED DESCRIPTION OF THE DRAWINGS

Various embodiments of the invention disclosed in my prior application of which this application forms a continuation-in-part and in my prior below-identified U.S. Patent will first be recited for completeness. Thereafter the specific embodiment which is the material of this patent will be described.

The use of a stippling in the drawing figures is intended to communicate the color red or another conspicuous color different from the background color of the surface.

The heat alert device of the present invention when used for the smooth surface of cooktop stoves of either type would comprise thermochromic composition 32 embedded in the top surface of each glass area 30, which is the heating element on the smooth cooktop stove using known methods. For example, the thermochromic composition 32 may be made in the exact shape of the letters “HOT” by spraying the composition of thermochromic material 32 over each glass area 30 after covering the glass area 30 with a cardboard stencil or other cut-out in the outline or shape of the letters “HOT”. As before, the liquid crystal or thermochromic composition is designed to turn red and remain red whenever the temperature of the smooth area of glass exceeds a specified temperature, such as 115 degrees Fahrenheit.

It should be noted in general that the present invention makes use of any thermochromic composition that changes color and remains at that color when a specified temperature is reached or exceeded—it need not necessarily be cholesteric, although it has been found that cholesteric liquid crystal material does this effectively. It is also within the scope of the present invention to make use of a thermochromic composition that changed color when it reached a specified temperature or temperature range but changed to a third color at a higher threshold temperature, so long as the third color is significantly different from the first color—although this would certainly not be the ideal kind of thermochromic composition. The ideal composition turns red at a specified temperature and remains red above that temperature.

With use of the present invention, when an individual enters the kitchen with the cook top stove in it he or she can instantly recognize if any of the heating elements are too hot. This is in contrast to the prior art for which the person would have to first figure out which heating element corresponds to which light indicator.

The present invention contemplates that other letters and other letter shapes besides that of “HOT” could be used as a warning although it is believed that the simple arrangement of the letters “HOT” in a bold simple typeset provide the best warning. Furthermore, the present invention also contemplates that the thermochromic composition in the outline of the letters “HOT” can be embedded in a surface of a stove, toaster oven or other appliance where the surface is vertical and perpendicular to the floor, not only horizontal. In addition, while the drawings depict the thermochromic composition embedded on the surface of the stove in a particular configuration and depth, it is contemplated by the present invention that the depth and configuration of the thermochromic composition can vary and still be within the scope of this invention.

It is also contemplated by the present invention that in addition to the thermochromic composition being in an outline of the heat warning symbol such as the letters “HOT”, the thermochromic composition could instead be in the background of such an outline. By this is meant that the thermochromic composition would form the entire area except an outline of the letters “HOT”. The point of one feature of the present invention is to use the thermochromic composition to create a color contrast between red and some other color in order to depict the letters “HOT” in red whether by virtue of the thermochromic composition itself being the letters “HOT” or whether the thermochromic composition surrounds the letters and in effect constitutes everything else except the letters “HOT”. Furthermore, it should be noted that in this patent application, the term “red” refers to all possible variations and shades of the color red as well as to all possible variations of the colors orange and yellow. Red and orange and yellow are the colors associated with heat. Furthermore, if the hot surface (as opposed to the area of the thermochromic composition) itself is or becomes red when hot, then the thermochromic composition would have to be orange and vice versa.

The term “appliance” is a broad term that encompasses any appliance and any object that has a hot surface. Many appliances have curved surfaces and the present invention can be applied directly to such surfaces, which further maximizes the viewing angle of the warning. The hot surfaces are typically metal or glass but can be of other suitable materials.

Two or more sides or walls of an appliance can sometimes get hot and the one side might not be suitable to have a heat alert safety device attached to it even though the same heat alert safety device of the present invention is made specifically for the other side of the same appliance. This application is especially useful for kitchen workers surrounded by multiple ovens and/or hot counters—they can place the device on each such hot surface. Other surfaces that get hot and to which device can be usefully applied besides food related appliances include radiator caps located under the hood of a car or other vehicle, piping through which hot steam flows, the surface of a curling iron, surfaces of a steam press and many others listed herein in the Objects and Advantages.

It will be understood that the various methods of attachment may be combined.

The apparatus of the present invention will now be illustrated by reference to the accompanying drawings. A single heat warning safety device in accordance with the present invention has been assigned reference numeral 10 An assembly of such devices has been assigned reference numeral 100. Other elements have been assigned the reference numerals referred to below.

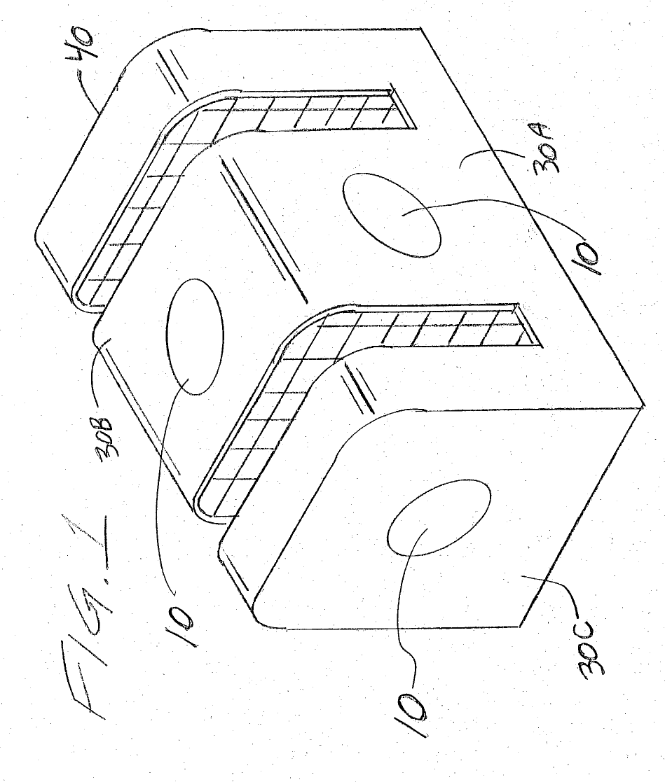

The present invention is designed to provide an overall system for heat warning safety devices that maximizes the effectiveness of the warnings. Although FIGS. 1 through 8 depict the assembly of heat warning devices applied to an ordinary toaster, it will be appreciated that the assembly and individual devices of the present invention are equally suitable for application to any surface that can become hot

As seen from FIGS. 1-8, heat warning safety device 10 is attachable to a surface of a toaster to warning individuals that the surfaces of the toaster is or are hot. Device 10 comprises thermochromic composition 20 shaped in a predetermined symbol or in the background of such symbol which communicates that the surface is dangerously hot, the symbol substantially invisible against a background color of surface 30 and designed to undergo and maintain a readily perceptible color change so that the symbol 20 is readily visible against said background color 30 whenever and so long as the temperature of the surface 30 exceeds a predetermined temperature,

FIG. 1 is intended to show the placement of the heat warning safety devices on an appliance such as a toaster. FIG. 1 shows the device 10 on a front f or a first surface 30A, a top t or second surface 30B and a side s or additional surface 30C of toaster 40. These can also be called a first surface, a second surface and a third surface. Alternatively, FIG. 1 could been example of a toaster having three type one 10A devices 10 when cold, as explained below.

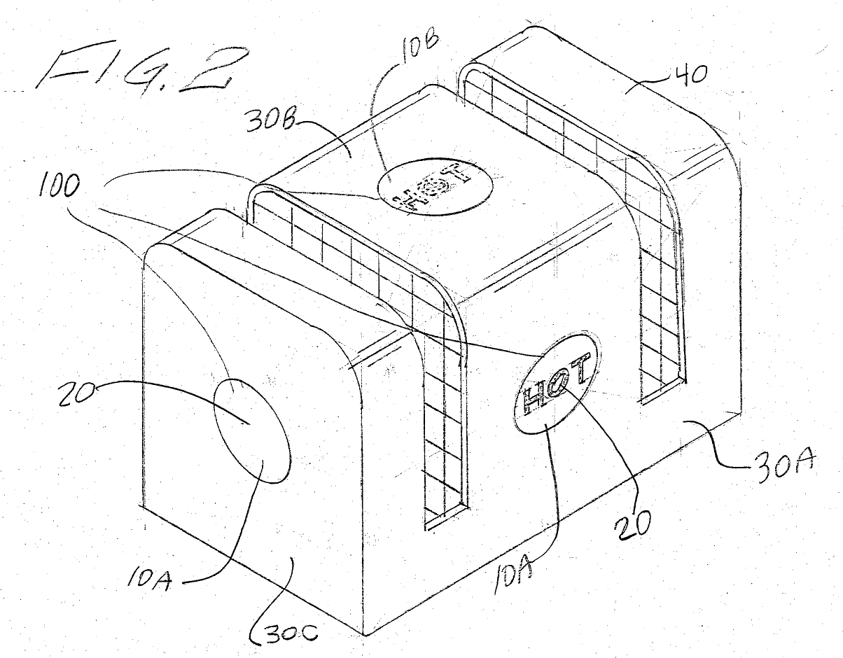

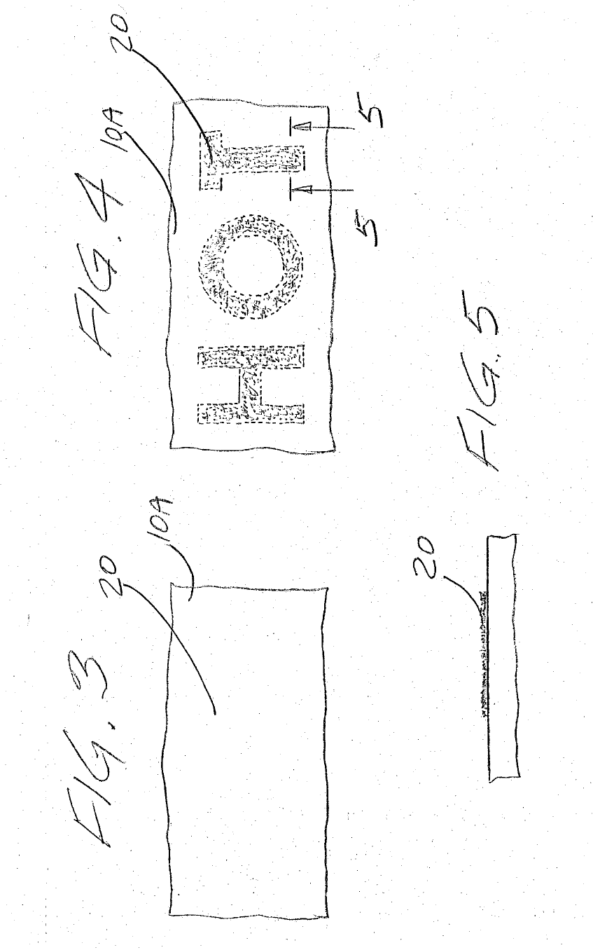

As seen in FIG. 2, there are two versions of the device 10, which can be referred to as a first type 10A and a second type 10B. As seen in FIG. 3, which appears blank, (and in the leftmost surface of FIG. 2) the first type 10A of device 10 is basically invisible or faintly visible when the device 10 is “off”, i.e. when the surface to which it is attached is cold. The term “cold” here simply means not dangerously hot as that term is defined. Dangerously hot typically although not necessarily may be 115 degrees Fahrenheit. The reason first type 10A is invisible is simply that the color of the thermochromic composition 20 is designed to be the same as the background color on the first surface 30A of the toaster 40 whenever the surface temperature does not exceed the specified temperature that would trigger the heat warning symbol to be activated. As seen in FIG. 4 and the front surface of FIG. 2, when the first surface 30A of the toaster 40 reaches the specified temperature, which may be 115 degrees Fahrenheit, first type 10A of device is activated so that the heat warning symbol, which in FIGS. 1-8 happens to be the letters “HOT”, turns red or some other noticeable color.

The first type 10A of device 10 is thus most suited for warning adults. A child cannot be expected to know where to look for a warning device. An adult, in contrast, can be taught to get used to the idea that a particular area of a surface is capable of changing color to communicate a warning and therefore one needs to look there to see if it is hot. The advantage of first type 10A of device 10 is that the visual change from invisible to conspicuous has a greater impact than a change from one color to a different color. Furthermore, by being invisible except when first surface 30A is dangerously hot, the logo of the manufacturer is not visually obstructed by additional information (i.e. the warning symbol) in a tight space that can only hold just so much visual information. This feature appeals to the manufacturer of the appliance.

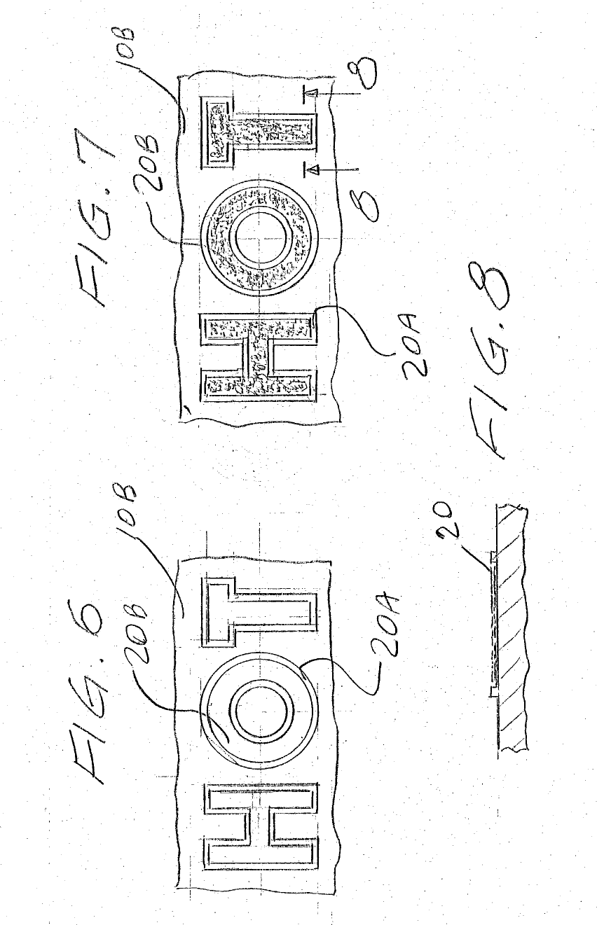

The second type 10B of device 10 is illustrated in FIGS. 6 and 7 as well as the top or second surface 30B of FIG. 2. As seen in FIG. 6 and the second surface 30B of the toaster 40 in FIG. 2, when cold (not dangerously hot), the second type 10B of device 10 is invisible or faintly visible except for the outline of the heat warning symbol, which in this case is the letters “HOT”. In other words, a remainder of the heat warning symbol of the second type 10B of device 10 is invisible or faintly visible and only the outline of the symbol is clearly visible. This is accomplished by having the outline 20A of the symbol being a permanent marking of a color different than the background color of the surface of the appliance whereas the remainder 20B of the symbol is a thermochromic composition 20B that is identical to the background color of the surface of the appliance (and which becomes red or another color different from the background color upon reaching a specified temperature).

This second type 10B of device 10 is most suited for warning children as to whom an invisible symbol when cold would not prompt or teach the child where to look for a warning. On the other hand, by limiting the visual portion to the outline, the visual space used by type two 10B of device 10 is minimized. By having both types of the device 10, an assembly 100 is custom tailored to all ages of individuals. As seen in FIG. 7, when the second surface 30B of the toaster 40 reaches the specified temperature, which may be 115 degrees Fahrenheit, second type 10B of device 10 is activated so that the heat warning symbol, which in FIGS. 1-8 happens to be the letters “HOT”, turns red or some other noticeable color.

When the thermochromic composition is applied by being sprayed, stenciled, embossed, stamped, silk screened or otherwise applied to the surface 30, the composition 20 is applied initially in a liquid or in a malleable solid form. Only then it dries or dries instantly. Accordingly, thermochromic composition 20 is capable of being applied as a liquid directly to the surface 30 in the predetermined shape and it is capable of remaining on surface 30 in its predetermined shape in solid form. It is capable of withstanding temperatures in excess of 300 degrees Fahrenheit.

It should be noted that thermochromic ink and epoxy compositions that withstand temperatures of at least 300 degrees Fahrenheit are commonly available. Although specialized thermochromic ink and epoxy compositions that withstand higher temperatures, such as 500 degrees Fahrenheit, are also known and available, such specialized thermochromic compositions should only be used if they are necessary. If such specialized compositions are not needed for a particular application, it is preferable to use the more commonly available compositions that only withstand temperatures of up to 300 degrees Fahrenheit. Accordingly, in applying the present invention to various kinds of surfaces, a determination should be made whether the surface is likely to require the more specialized ink and epoxy thermochromic ink and epoxy composition or the more commonly available thermochromic ink and epoxy composition..

Certain surfaces that require a heat warning safety device do not become hotter than 300 degrees Fahrenheit. One reason for this is that it is useful to place the heat warning safety device 10 of the present invention on outer housing surfaces of grills or other appliances in addition to the areas closer to the heating elements. While the heating element itself and the areas immediately proximate to it may well exceed 300 degrees Fahrenheit, the area on the housing of a grill or other appliance is not likely to exceed a temperature of 300 degrees Fahrenheit under normal use. Accordingly, for these application the device 10 of the present invention employs a thermochromic ink or epoxy composition suitable for surfaces that are not likely to exceed a temperature of 300 degrees Fahrenheit.

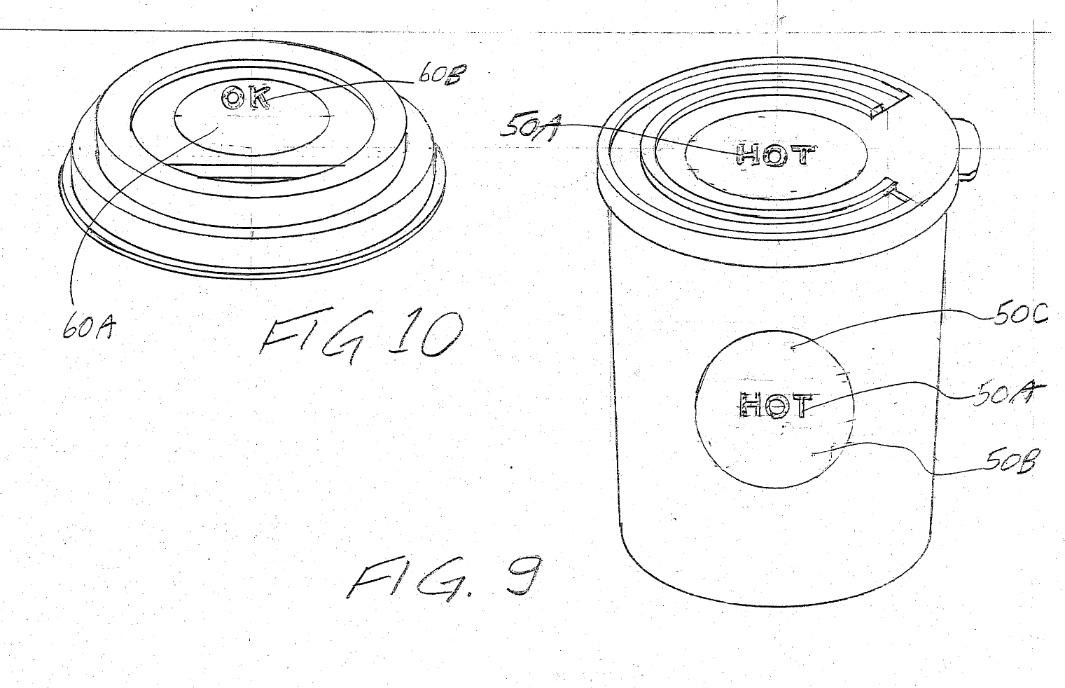

As best seen in FIG. 5 and FIG. 8, thermochromic composition 20 is very thin. It has the thickness of written ink embossed, sprayed or otherwise applied to a smooth surface. For example, a smooth surface of an appliance may have embossed thereon a particular logo or product name. If an individual were to close his eyes and feel that surface they would be able to feel the raised ink but only barely. Accordingly, the thickness in solid form of thermochromic composition 20 is such that the thermochromic composition is either faintly visible or invisible when viewed from a line of light tangent to the surface 30 by someone whose attention is not specifically directed to said thermochromic composition. Although FIGS. 5 and 8 do show a visible surface, that is simply to illustrate the fact that there is at least some thickness and is not intended to be to scale.

Typically, composition 20 is applied as a liquid directly to the surface by being sprayed, stamped, stenciled, embossed or silk screened onto said surface. Thermochromic compositions that are suitable are well known and include inks and epoxy resins. For example, the following are examples of thermochromic compositions made by various companies that are applicable to the present invention. Hallcrest, Inc. makes color change products that are temperature sensitive. For example, Hallcrest, Inc. manufactures microencapsulated thermochromic liquid crystal slurries and sprayable microencapsulated thermochromic liquid crystal coatings. Chromatic Technologies, Inc. manufacturers Dynacolor® Resin for epoxy screen ink. Matsui International Company, Inc. manufacturers a product called Chromicolor® which is an epoxy resin spray paint.

The present invention can also be thought of as an assembly 100 of devices 10 of the present invention. The combination of the devices 10 forming assembly 100 provides a system of maximum protection to a whole family of individuals that any and all surfaces of the appliance or other object can be protected with warning devices. For example, a toaster's surfaces may cool to below the specified temperature at different times so the user needs

The assembly 100 includes a plurality of heat alert warning devices that can be placed on more than one surface of an appliance. The assembly 100 includes one or more devices of a first type 10A attachable to a first surface 30A of the appliance, the device of the first type 10A comprising a thermochromic composition 20 shaped in a predetermined symbol or in the background of such symbol which communicates that the surface is dangerously hot, the symbol substantially invisible against a background color of the surface and designed to undergo and maintain a readily perceptible color change so that the symbol is readily visible against said background color whenever and so long as the temperature of the surface exceeds a predetermined temperature, the thermochromic composition capable of being applied as a liquid directly to the first surface in the predetermined shape, capable of remaining on the first surface in its predetermined shape in solid form, and capable of withstanding temperatures in excess of 300 degrees Fahrenheit, the thickness in solid form of said thermochromic composition being such that said thermochromic composition is either faintly visible or invisible when viewed from a line of sight tangent to the first surface by someone whose attention is not specifically directed to said thermochromic composition. the assembly 100 also includes one or more devices of a second type 10B attachable to a second surface 30B of the appliance, said device of the second type comprising a thermochromic composition shaped in a predetermined symbol or in the background of such symbol which communicates that the surface is dangerously hot, wherein an outline of the symbol is visible against a background color of the surface and a remainder of the symbol is substantially invisible against a background color of the surface, the remainder of the symbol designed to undergo and maintain a readily perceptible color change so that said remainder is readily visible against said background color whenever and so long as the temperature of the surface exceeds a predetermined temperature, the thermochromic composition capable of being applied as a liquid directly to the surface in the predetermined shape, capable of remaining on said surface in its predetermined shape in solid form, and capable of withstanding temperatures in excess of 300 degrees Fahrenheit, the thickness in solid form of the thermochromic composition being such that said thermochromic composition is either faintly visible or invisible when viewed from a line of sight tangent to the second surface by someone whose attention is not specifically directed to said thermochromic composition. The assembly 100 could be limited to the two surfaces or could optionally also include one or more additional devices that are of the first type or of the second type attachable to one or more additional surfaces of the appliance.

The assembly 100 can include as many devices 10 as is practical and appropriate. Furthermore, the assembly 100 contemplates that can be more than one device 10 of the first type 10A on the first surface 30A and more than one device 10 of the second type 10B on a second surface 30B.

Multiple Segment Embodiment

The present invention also contemplates that the device 10 can communicate not just that a surface is dangerously hot but also varying levels of dangerously hot, i.e. varying degrees of heat on that surface. As seen in FIGS. 9, 10, 13A and 13B, the device 10 can be divided in segments of two, three or any other number. Typically, there would not be more than three segments because it is not necessary usually to communicate more than three levels of heat. In addition, one does not want to clog the visual space of the surface.

In accordance with this embodiment, the heat warning safety device 10 can be described as comprising a thermochromic composition 20 shaped in a predetermined symbol, the symbol having multiple segments, or in the background of such symbol, which symbol communicates that the surface is dangerously hot to a particular level, each segment 50A, 50B except one communicating a different level of a degree to which the surface is dangerously hot and one segment 50C communicating that the surface is not dangerously hot until the surface temperature exceeds the predetermined temperature, all segments of the symbol except one substantially invisible against a background color of the surface and at least one segment of said symbol designed to undergo and maintain a readily perceptible color change so that said at least one segment is readily visible against said background color whenever and so long as the temperature of the surface exceeds the predetermined temperature, and a second segment of the symbol designed to undergo and maintain a readily perceptible color change so that said second segment is readily visible against the background color whenever and so long as the temperature of the surface exceeds a second predetermined temperature, said second predetermined temperature being higher than said predetermined temperature, the thermochromic composition capable of being applied as a liquid directly to the surface in the predetermined shape, capable of remaining on said surface in its predetermined shape in solid form, and capable of withstanding temperatures in excess of 300 degrees Fahrenheit, the thickness in solid form of said thermochromic composition being such that said thermochromic composition is either faintly visible or invisible when viewed from a line of light tangent to the surface by someone whose attention is not specifically directed to said thermochromic composition.

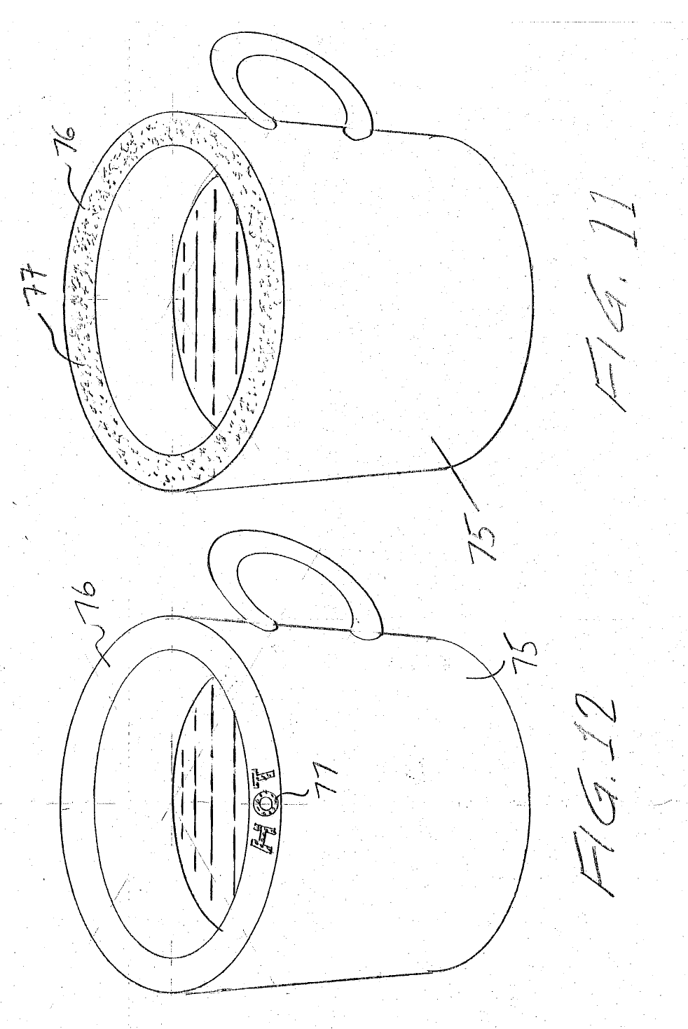

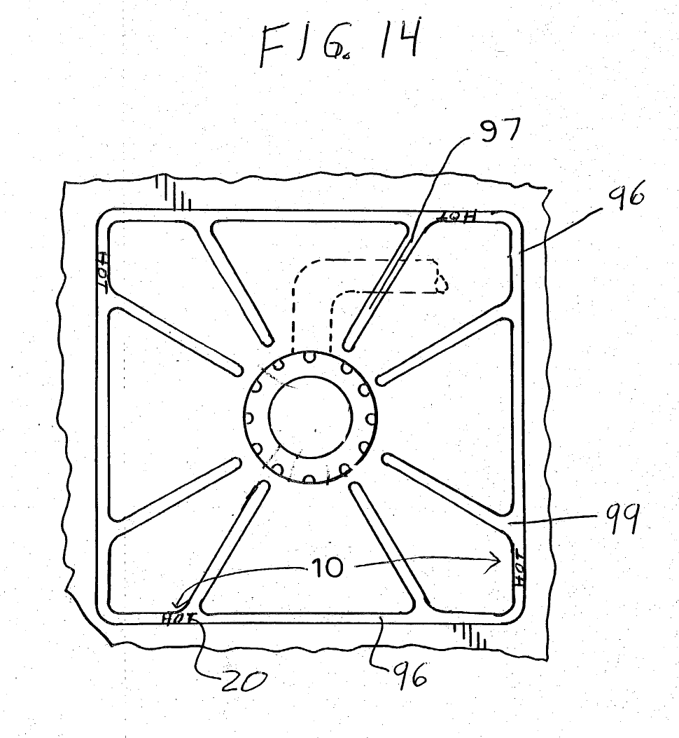

For example, as seen in FIGS. 14 in general and FIG. 9 as applied to a cup and a lid, one segment of symbol would for example communicate the word “OK” to tell the consumer that they can put the appliance away and it is not hot. Among the remaining two segments, a first segment would communicate the word “HOT” when the surface exceeded the predetermined temperature and a second segment would communicate “VERY HOT” whenever and so long as the surface temperature exceeded a second (higher) predetermined temperature. FIG. 13 in general and FIG. 10 applied to a lid of a cup, show the same idea except there are only two segments of the heat warning symbol—the “HOT” segment 60A that communicates that the temperature of the surface exceeded a predetermined temperature and which is presently invisible and the “OK” segment 60B that affirmatively communicates that the surface is not dangerously hot and be touched or moved and which is depicted as visible. Accordingly, even though only one of the segments is active in the drawings of these segmented symbols in FIGS. 9-10 and 13-14, there are one or two other segments that although invisible contain another symbol segment For example, in FIG. 14, only the “VERY HOT” segment is active, the “OK” and the “HOT” segments are invisible since they are not active.

The above segment 50C which notifies the consumer that the surface is no dangerously hot can be accomplished by a thermochromic composition since thermochromic composition are well known to change color in either direction. In other words, instead of turning red for example when the predetermined temperature is exceeded, as is the case with the segments communicating “HOT” and “VERY HOT”, the segment communicating “OK” turns red or another color different than the background color whenever the temperature goes below the predetermined temperature.

It should be noted that although FIGS. 9, 10, 13 and 14 depict the segments are part of a type one symbol—i.e. it is invisible when not active and it is visible when active (as opposed to a type two symbol whose outline is always visible even when not active)—it is of course contemplated by the present invention that the same segment embodiment or other alternative embodiment can be accomplished using the type two symbols or even combinations of the two types of symbols.

It should be noted that FIGS. 9, 10, 13 and 14 do not depict lines dividing the segments within a symbol. The present invention only contemplates using the thermochromic composition to do so where doing so does not impair the objective of not clogging the visual space.

The present invention also contemplates combining the segment embodiment with the assembly embodiment. Accordingly, assembly 100 of devices 10 incorporates the “segment” embodiment just described. Such an assembly can be described as a heat warning safety device assembly 100 attachable to multiple surfaces of an appliance, the assembly 100 for warning individuals that one of more of the surfaces are hot. The assembly 100 comprises a plurality of heat alert warning devices including one or more devices of a first type 10A attachable to a first surface 30A of the appliance, the device of the first type 10A comprising a thermochromic composition shaped in a predetermined symbol, the symbol having multiple segments, or in the background of such symbol, which symbol communicates that the first surface is dangerously hot to a particular level, each segment except one communicating a different level of a degree to which the first surface is dangerously hot and one segment communicating that the first surface is not dangerously hot, the symbol substantially invisible against a background color of the surface and at least one segment of said symbol designed to undergo and maintain a readily perceptible color change so that said at least one segment is readily visible against said background color whenever and so long as the temperature of the surface exceeds a predetermined temperature, and a second segment of said symbol designed to undergo and maintain a readily perceptible color change so that said second segment is readily visible against said background color whenever and so long as the temperature of the surface exceeds a second predetermined temperature, said second predetermined temperature (i.e. “VERY HOT”) being higher than said predetermined temperature (i.e. “HOT”), the thermochromic composition capable of being applied as a liquid directly to the surface in the predetermined shape, capable of remaining on said surface in its predetermined shape in solid form, and capable of withstanding temperatures in excess of 300 degrees Fahrenheit, the thickness in solid form of said thermochromic composition being such that said thermochromic composition is either faintly visible or invisible when viewed from a line of sight tangent to the first surface by someone whose attention is not specifically directed to said thermochromic composition. This assembly 100 also includes one or more devices of a second type 10B attachable to a second surface 30B of the appliance. The device of the second type 10B comprises a thermochromic composition shaped in a predetermined symbol or in the background of such symbol which communicates that the surface is dangerously hot, wherein an outline of the symbol is visible against a background color of the surface and a remainder of the symbol is substantially invisible against a background color of the surface, and wherein the remainder of the symbol is designed to undergo and maintain a readily perceptible color change so that said remainder is readily visible against said background color whenever and so long as the temperature of the surface exceeds a predetermined temperature. As before, the thermochromic composition is capable of being applied as a liquid directly to the surface in the predetermined shape, capable of remaining on said surface in its predetermined shape in solid form, and capable of withstanding temperatures in excess of 300 degrees Fahrenheit. The thickness in solid form of the thermochromic composition is such that the thermochromic composition is either faintly visible or invisible when viewed from a line of sight tangent to the second surface by someone whose attention is not specifically directed to said thermochromic composition.

Optionally, assembly 100 also includes one or more additional devices that are of the first type or of the second type and that are attachable to one or more additional surfaces of the appliance.

It should be noted that in this description only the first type 10A of device 10 in assembly 100 is segmented to communicate varying degrees of heat including “VERY HOT”, “HOT” and “OK”. However, the present invention certainly also contemplates embodiments in which the second type 10B of device 10 in assembly 100 is segmented. The present invention also contemplates an embodiment in which both the first type 10A and the second type 10B of device 10 are segmented. Furthermore, there can be additional devices on additional surfaces that can be segmented. Furthermore, it is also contemplated by the present invention that the amount of segmentation (the number of segments in the heat warning symbol) and the type of segmentation (the subsymbol used in the segment) can vary from one surface to another within the assembly of devices and even can vary within the devices that are placed on a single surface of an appliance.

Additional Embodiments

As seen in FIGS. 9-10, the present invention also contemplates an embodiment wherein a heat warning safety device is attachable to a cup or the lid of a cup or other container that holds a hot liquid, for advertising the temperature of the liquid. Such a device 80 comprises a thermochromic composition shaped in a predetermined symbol or in the background of such symbol which communicates that a top surface of the lid is dangerously hot, the symbol substantially invisible against a background color of the surface and designed to undergo and maintain a readily perceptible color change so that the symbol is readily visible against said background color whenever and so long as the temperature of the top surface of the lid exceeds a predetermined temperature, said predetermined temperature of the top surface of the lid calibrated to reflect a higher temperature of the liquid in the cup by taking into consideration an expected specified amount of heat dissipation between the liquid and the lid, the thermochromic composition capable of being applied as a liquid directly to the surface in the predetermined shape, capable of remaining on said surface in its predetermined shape in solid form, and capable of withstanding temperatures in excess of 300 degrees Fahrenheit, the thickness in solid form of said thermochromic composition being such that said thermochromic composition is either faintly visible or invisible when viewed from a line of light tangent to the surface by someone whose attention is not specifically directed to said thermochromic composition.

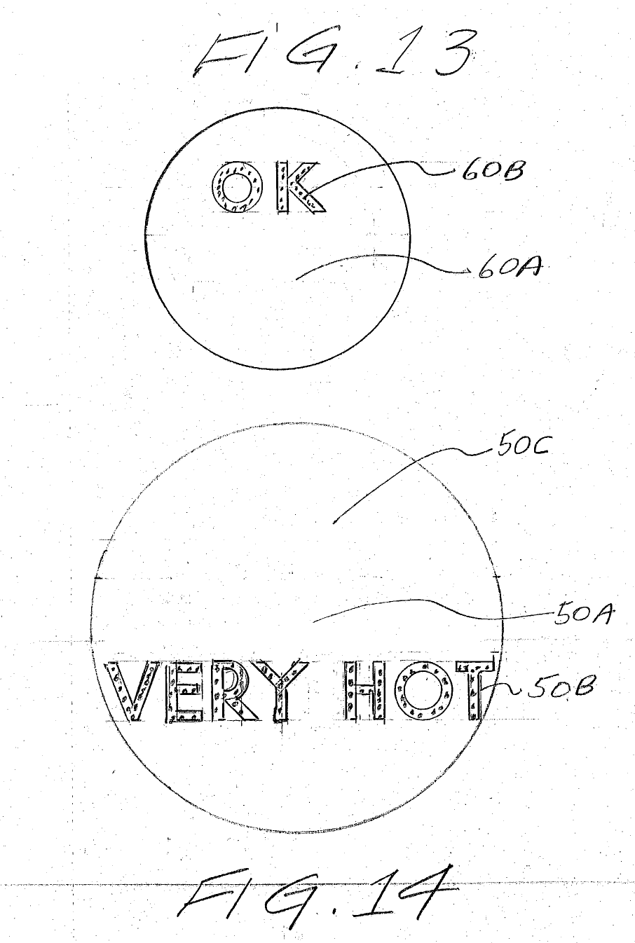

FIGS. 11-12 depict an embodiment wherein the thermochromic composition appears on the lip of a mug. Alternatively, it can appear on the lip of a cup or other container holding a beverage. This serves the dual purpose of warning that the liquid is hot and also advertising that the liquid actually stays hot. In other words, Starbucks® or other companies that would like consumers to know that their coffee or other beverage is hot while it is being carried around by a consumer who has already left the shop they purchased it in, can achieve this advertising objective using the heat warning symbol of the present invention.

FIG. 11 shows the heat warning symbol made of thermochromic composition as a continuous red lip that became red when the predetermined temperature on the lip has been exceeded. That lip temperature has been calibrated to take into consideration the heat dissipation from the liquid, i.e. the difference between the temperature of the lip and the temperature of the liquid. FIG. 12 shows the symbol in a form of the letters “HOT on the lip as an alternative.

In the embodiment shown in FIGS. 11 and FIG. 12, since the thermochromic composition is on the lip of a beverage container that is in contact with a human being's lips, said thermochromic composition would be glazed over with the material of the mug for safety and hygiene reasons. Accordingly, in this particular embodiment, the thickness of the thermochromic composition need not be a major concern.

Accordingly, FIGS. 11-12 describe a beverage container containing a heat warning safety device attachable to a lip of the beverage container that holds a hot liquid, for advertising the temperature of the liquid, comprising a beverage container 75 including a lip on said beverage container, a thermochromic composition 77 shaped in a predetermined symbol or in the background of such symbol which communicates that the lip of a beverage container is hot, the symbol substantially invisible against a background color of the lip and designed to undergo and maintain a readily perceptible color change so that the symbol is readily visible against said background color whenever and so long as the temperature of the lip exceeds a predetermined temperature, said predetermined temperature of the lip calibrated to reflect a higher temperature of the liquid in the beverage container by taking into consideration an expected specified amount of heat dissipation between the liquid and the lip, and a transparent glazed material covering said thermochromic composition.

Grill Embodiment

In an additional embodiment, which embodiment employs a thermochromic composition 20 that withstands at least 500 degrees Fahrenheit, the heat warning symbol made of thermochromic composition 20 in device 10 is located on a flat surface of the base which is at the outer perimeter of a metal grate 99 which is the heating element of a gas stove. Often that flat surface is approximately one half inch to three quarters of an inch wide. That location is ideal for several reasons. First, since the outer perimeter base 96 of metal grate 99 has to be crossed before a person's hand touches the metal grate, it maximizes the effectiveness of the warning. Second, the outer perimeter base 96 is lower than the prongs 97 of the metal grate 99, so pots or other cookware placed on the grate 99 do not rub against and wear out device 10 located on the outer perimeter base.

The same idea applies to a barbecue grill. The grill has an outer perimeter whose top surface is slightly lower than the surface of the grill that the meat is placed on. the device 10 would be placed on that outer perimeter. A griddle has a similarly advantageous perimter to place device 10 on.

In general, it is to be understood that while the apparatus of this invention have been described and illustrated in detail, the above-described embodiments are simply illustrative of the principles of the invention. It is to be understood also that various other modifications and changes may be devised by those skilled in the art which will embody the principles of the invention and fall within the spirit and scope thereof It is not desired to limit the invention to the exact construction and operation shown and described. The spirit and scope of this invention are limited only by the spirit and scope of the following claims.

What is claimed is:

1. A heat warning safety device attachable to a surface, such as metal or glass, for warning individuals that the surface is hot, comprising:
a thermochromic composition shaped in a predetermined symbol or in the background of such symbol which communicates that the surface is dangerously hot, the symbol substantially invisible against a background color of the surface and designed to undergo and maintain a readily perceptible color change so that the symbol is readily visible against said background color whenever and so long as the temperature of the surface exceeds a predetermined temperature,
the thermochromic composition capable of being applied as a liquid directly to the surface in the predetermined shape, capable of remaining on said surface in its predetermined shape in solid form, and capable of withstanding temperatures in excess of 300 degrees Fahrenheit,
the thickness in solid form of said thermochromic composition being such that said thermochromic composition is either faintly visible or invisible when viewed from a line of light tangent to the surface by someone whose attention is not specifically directed to said thermochromic composition.

2. The device of claim 1, wherein the composition is capable of being applied as a liquid directly to the surface by being sprayed, stamped, stenciled, embossed or silk screened onto said surface.

3. The device of claim 1, wherein the thermochromic composition is ink.

4. The device of claim 1, wherein the thermochromic composition is epoxy resin.

5. A heat warning safety device attachable to a surface, such as metal or glass, for warning individuals that the surface is hot, comprising:
a thermochromic composition shaped in a predetermined symbol, the symbol having multiple segments, or in the background of such symbol, which symbol communicates that the surface is dangerously hot to a particular level, each segment except one communicating a different level of a degree to which the surface is dangerously hot and one segment communicating that the surface is not dangerously hot until a predetermined temperature of the surface is exceeded, all segments of the symbol except one substantially invisible against a background color of the surface and at least one segment of said symbol designed to undergo and maintain a readily perceptible color change so that said at least one segment is readily visible against said background color whenever and so long as the temperature of the surface exceeds the predetermined temperature, and a second segment of said symbol designed to undergo and maintain a readily perceptible color change so that said second segment is readily visible against said background color whenever and so long as the temperature of the surface exceeds a second predetermined temperature, said second predetermined temperature being higher than said predetermined temperature,
the thermochromic composition capable of being applied as a liquid directly to the surface in the predetermined shape, capable of remaining on said surface in its predetermined shape in solid form, and capable of withstanding temperatures in excess of 300 degrees Fahrenheit, the thickness in solid form of said thermochromic composition being such that said thermochromic composition is either faintly visible or invisible when viewed from a line of light tangent to the surface by someone whose attention is not specifically directed to said thermochromic composition.

6. The device of claim 5, wherein the composition is capable of being applied as a liquid directly to the surface by being sprayed, stamped, stenciled, embossed or silk screened onto said surface.

7. The device of claim 5, wherein the thermochromic composition is ink.

8. The device of claim 5, wherein the thermochromic composition is epoxy resin.

9. The device of claim 5, wherein the symbol has multiple segments indicating different degrees of dangerously hot and wherein one particular segment is programmed to be active at a time.

10. A heat warning safety device assembly attachable to multiple surfaces of an appliance, said assembly for warning individuals that one of more of the surfaces are hot, comprising: a plurality of heat alert warning devices including
one or more devices of a first type attachable to a first surface of the appliance, said device of the first type comprising a thermochromic composition shaped in a predetermined symbol or in the background of such symbol which communicates that the surface is dangerously hot, the symbol substantially invisible against a background color of the surface and designed to undergo and maintain a readily perceptible color change so that the symbol is readily visible against said background color whenever and so long as the temperature of the surface exceeds a predetermined temperature,
the thermochromic composition capable of being applied as a liquid directly to the surface in the predetermined shape, capable of remaining on said surface in its predetermined shape in solid form, and capable of withstanding temperatures in excess of 300 degrees Fahrenheit, the thickness in solid form of said thermochromic composition being such that said thermochromic composition is either faintly visible or invisible when viewed from a line of sight tangent to the first surface by someone whose attention is not specifically directed to said thermochromic composition, and
one or more devices of a second type attachable to a second surface of the appliance, said device of the second type comprising a thermochromic composition shaped in a predetermined symbol or in the background of such symbol which communicates that the surface is dangerously hot, wherein an outline of the symbol is visible against a background color of the surface and a remainder of the symbol is substantially invisible against a background color of the surface, the remainder of the symbol designed to undergo and maintain a readily perceptible color change so that said remainder is readily visible against said background color whenever and so long as the temperature of the surface exceeds a predetermined temperature, the thermochromic composition capable of being applied as a liquid directly to the surface in the predetermined shape, capable of remaining on said surface in its predetermined shape in solid form, and capable of withstanding temperatures in excess of 300 degrees Fahrenheit, the thickness in solid form of the thermochromic composition being such that said thermochromic composition is either faintly visible or invisible when viewed from a line of sight tangent to the second surface by someone whose attention is not specifically directed to said thermochromic composition.

11. The assembly of claim 10, wherein said assembly also includes one or more additional devices that are of the first type or of the second type attachable to one or more additional surfaces of the appliance.

12. The assembly of claim 11, wherein the thermochromic composition is capable of being applied as a liquid directly to the surface by being sprayed, stamped, stenciled, embossed or silk screened onto said surface.

13. The device of claim 11, wherein the thermochromic composition is ink.

14. The device of claim 11, wherein the thermochromic composition is epoxy resin.

15. A heat warning safety device assembly attachable to multiple surfaces of an appliance, said assembly for warning individuals that one of more of the surfaces are hot, comprising: a plurality of heat alert warning devices including
one or more devices of a first type attachable to a first surface of the appliance, said device of the first type comprising
a thermochromic composition shaped in a predetermined symbol, the symbol having multiple segments, or in the background of such symbol, which symbol communicates that the first surface is dangerously hot to a particular level, each segment except one communicating a different level of a degree to which the first surface is dangerously hot and one segment communicating that the first surface is not dangerously hot until a predetermined temperature is exceeded, all segments of the symbol except one substantially invisible against a background color of the surface and at least one segment of said symbol designed to undergo and maintain a readily perceptible color change so that said at least one segment is readily visible against said background color whenever and so long as the temperature of the surface exceeds the predetermined temperature, and a second segment of said symbol designed to undergo and maintain a readily perceptible color change so that said second segment is readily visible against said background color whenever and so long as the temperature of the surface exceeds a second predetermined temperature, said second predetermined temperature being higher than said predetermined temperature,
the thermochromic composition capable of being applied as a liquid directly to the surface in the predetermined shape, capable of remaining on said surface in its predetermined shape in solid form, and capable of withstanding temperatures in excess of 300 degrees Fahrenheit, the thickness in solid form of said thermochromic composition being such that said thermochromic composition is either faintly visible or invisible when viewed from a line of sight tangent to the first surface by someone whose attention is not specifically directed to said thermochromic composition, and
one or more devices of a second type attachable to a second surface of the appliance, said device of the second type comprising a thermochromic composition shaped in a predetermined symbol or in the background of such symbol which communicates that the surface is dangerously hot, wherein an outline of the symbol is visible against a background color of the surface and a remainder of the symbol is substantially invisible against a background color of the surface, the remainder of the symbol designed to undergo and maintain a readily perceptible color change so that said remainder is readily visible against said background color whenever and so long as the temperature of the surface exceeds a predetermined temperature, the thermochromic composition capable of being applied as a liquid directly to the surface in the predetermined shape, capable of remaining on said surface in its predetermined shape in solid form, and capable of withstanding temperatures in excess of 300 degrees Fahrenheit, the thickness in solid form of the thermochromic composition being such that said thermochromic composition is either faintly visible or invisible when viewed from a line of sight tangent to the second surface by someone whose attention is not specifically directed to said thermochromic composition.

16. The assembly of claim 15, wherein said assembly also includes one or more additional devices that are of the first type or of the second type attachable to one or more additional surfaces of the appliance.

17. The assembly of claim 16, wherein the thermochromic composition is capable of being applied as a liquid directly to the surface by being sprayed, stamped, stenciled, embossed or silk screened onto said surface.

18. The assembly of claim 16, wherein the thermochromic composition is ink.

19. The assembly of claim 16, wherein the thermochromic composition is epoxy resin.

20. A heat warning safety device attachable to a surface of a metal heating element, such as a grate, grill or griddle, for warning individuals that the surface is hot, comprising:
a thermochromic composition shaped in a predetermined symbol or in the background of such symbol which communicates that the surface is dangerously hot, the symbol substantially invisible against a background color of the surface and designed to undergo and maintain a readily perceptible color change so that the symbol is readily visible against said background color whenever and so long as the temperature of the surface exceeds a predetermined temperature,
the thermochromic composition capable of being applied as a liquid directly to the surface in the predetermined shape, capable of remaining on said surface element in its predetermined shape in solid form, and capable of withstanding temperatures in excess of 500 degrees Fahrenheit,
the thickness in solid form of said thermochromic composition being such that said thermochromic composition is either faintly visible or invisible when viewed from a line of light tangent to the surface by someone whose attention is not specifically directed to said thermochromic composition.

21. The device of claim 20, wherein the surface of the metal heating element that the thermochromic composition is located on is the surface of an outer perimeter base of said metal heating element.

22. The device of claim 21, wherein the composition is capable of being applied as a liquid directly to the surface by being sprayed, stamped, stenciled, embossed or silk screened onto said surface.

23. The device of claim 20, wherein the thermochromic composition is ink.

24. The device of claim 20, wherein the thermochromic composition is epoxy resin.

25. A heat warning safety device attachable to a surface of a metal heating element, such as a grate, grill or griddle, for warning individuals that the surface is hot, comprising:
a thermochromic composition shaped in a predetermined symbol or in the background of such symbol which communicates that the surface is dangerously hot, the symbol designed to undergo and maintain a readily perceptible color change so that the symbol is readily visible against said background color whenever and so long as the temperature of the surface exceeds a predetermined temperature,
the thermochromic composition capable of being applied as a liquid directly to the surface in the predetermined shape, capable of remaining on said surface element in its predetermined shape in solid form, and capable of withstanding temperatures in excess of 500 degrees Fahrenheit,
the thickness in solid form of said thermochromic composition being such that said thermochromic composition is either faintly visible or invisible when viewed from a line of light tangent to the surface by someone whose attention is not specifically directed to said thermochromic composition.

26. The device of claim 25, wherein the surface of the metal heating element that the thermochromic composition is located on is the surface of an outer perimeter base of said metal heating element.

27. The device of claim 26, wherein the composition is capable of being applied as a liquid directly to the surface by being sprayed, stamped, stenciled, embossed or silk screened onto said surface.

28. The device of claim 25, wherein the thermochromic composition is ink.

29. The device of claim 25, wherein the thermochromic composition is epoxy resin.
